(19) United States
(12) Patent Application Publication
(10) Pub. No.: US 2007/0160843 A1
(43) Pub. Date: Jul. 12, 2007

(54) Coated cemented carbide inserts

(75) Inventors: Malin Martensson, Nacka (SE); Mats Ahlgren, Taby (SE); Anders Jonsson, Gavle (SE); Marcus Hillbom, Gavle (SE); Martin Hansson, Gavle (SE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/637,217

(22) Filed: Dec. 12, 2006

(30) Foreign Application Priority Data
Dec. 14, 2005 (SE) 0502747-9
Dec. 14, 2005 (SE) 0601758-6

(51) Int. Cl. B32B 9/00

(52) U.S. Cl. 428/408

(57) ABSTRACT

The present invention relates to a cutting insert for parting and grooving in heat resistant super alloys and stainless steels comprising a substrate and a coating. The substrate comprises of from about 5 to about 7 wt-% Co and from about 0.15 to about 0.60 wt-% TaC and from about 0.10 to about 0.50 wt-% NbC and balance WC. The coating comprises a homogeneous AlₓTi₁₋ₓN-layer with x=from about 0.6 to about 0.7 and a thickness of from about 1 to about 3.8 μm.

### BACKGROUND OF THE INVENTION

The present invention relates to a coated cutting tool insert for parting and grooving in heat resistant super alloys and stainless steels. A relatively thin PVD-layer greatly improves the flank wear resistance, the coating adhesion and the notch wear resistance and a fine grained substrate provides good resistance against plastic deformation.

Coated cutting tool inserts for parting and grooving in heat resistant super alloys and stainless steels and particularly their edge line must have the following properties:

1. High resistance against plastic deformation, since the cutting process generates a high temperature in the cutting edge and the insert.

2. Good resistance against abrasive wear in order to avoid a rapidly growing flank wear.

3. Good resistance against adhesion wear and very good adhesion between the substrate and the coating. The chips from heat resistant super alloys and stainless steels are very prone to welding onto the surface of the insert.

4. Good resistance against notch wear, which occurs at the depth of cut and at the secondary cutting edge.

5. Good edge line toughness in order to avoid breakage and chipping. When machining heat resistant super alloys and stainless steels it is normally difficult to achieve good chip control, which will result in chip hammering and chip jamming causing fracture in the edge line.

U.S. Pat. No. 6,261,673 discloses a coated cemented carbide insert useful for grooving or parting of steel components such as steel or stainless steel tubes and bars. The insert is characterized by a WC-Co-based cemented carbide substrate having a highly W-alloyed Co-binder phase and a relatively thin coating including an inner layer of TiCₓN_{y}O_{z} with columnar grains followed by a layer of fine grained κ-Al₂O₃ and a top layer of TiN.

U.S. Pat. No. 6,342,291 discloses a coated cutting tool useful for grooving or parting of steel components such as steel or stainless steel tubes and bars. The insert is characterized by WC-Co-based cemented carbide substrate having a highly W-alloyed Co-binder phase and a hard and wear resistant coating including a multilayered structure of sublayers of the composition (TiₓAl₁₋ₓ)N with repeated variation of the Ti/Al ratio.

### OBJECTS AND SUMMARY OF THE INVENTION

It is an object of the present invention to provide a cutting tool insert particularly useful for parting and grooving in heat resistant super alloys and stainless steels.

It is a further object of the present invention to provide a cutting tool insert with improved wear and notch resistance and improved coating adhesion along the edge line.

In one aspect of the invention, there is provided a cutting insert for parting and grooving of heat resistant super alloys and stainless steels comprising a substrate and a coating wherein said substrate comprises from about 5 to about 7 wt-% Co, from about 0.15 to about 0.60 wt-% TaC, from about 0.10 to about 0.50 wt-% NbC, balance WC, a coercivity of from about 19.5 to about 24.5 kA/m, a CW-ratio of from about 0.85 to about 1.00, and said coating comprises a homogeneous AlₓTi₁₋ₓN-layer with x=from about 0.6 to about 0.67 and a thickness of greater than about 1 μm but less than about 3.8 μm.

In another aspect of the invention, there is provided the method of making a coated cutting tool insert for parting and grooving of heat resistant super alloys and stainless steels of a substrate and a coating comprising using conventional powder metallurgical techniques of milling, pressing and sintering, the substrate comprising from about 5 to about 7 wt-% Co and from about 0.15 to about 0.60 wt-% TaC and from about 0.10 to about 0.50 wt-% NbC, balance WC, a coercivity of from about 19.5 to about 24.5 kA/m, a CW-ratio of from about 0.85 to about 1.00, and after conventional post-sintering treatment, depositing a coating comprising a homogeneous AlₓTi₁₋ₓN-layer with x=from about 0.6 to about 0.67 by cathodic arc evaporation using a target material of TiAl-alloy in an N₂ gas atmosphere whereby the total thickness of the coating is greater than about 1 μm but less than about 3.8 μm.

In still another aspect of the invention, there is provided the use of the insert described above for parting, grooving in heat resistant super alloys, stainless steels and austenitic stainless steel at a cutting speed of from about 30 to about 250 m/min and a feed of from about 0.05 to about 0.2 mm/rev.

### DETAILED DESCRIPTION OF THE PREFERRED EMBODIMENTS

It has now been found that a relatively thin homogenous (Ti, Al)N PVD-layer greatly improves the flank and notch wear resistance as well as reduces the adhesion wear and in combination with a fine grained substrate provides good resistance against plastic deformation.

The present invention thus relates to a coated cutting tool insert comprising a cemented carbide substrate and a coating. The cemented carbide substrate comprises from about 5 to about 7 wt-% of Co, preferably from about 5.8 to about 6.2 wt-% Co, most preferably about 6.0 wt-% Co, from about 0.15 to about 0.60 wt-%, preferably from about 0.20 to about 0.30 wt-% TaC, from about 0.10 to about 0.50 wt-%, preferably from about 0.10 to about 0.20 wt-% NbC and balance WC. The cemented carbide body may also contain smaller amounts of other elements, but then at a level corresponding to a technical impurity. The coercivity is from about 19.5 to about 24.5 kA/m.

The cobalt binder phase is alloyed with a certain amount of W giving the invented cemented carbide cutting insert its desired properties. W in the binder phase influences the magnetic properties of cobalt and can hence be related to a CW-ratio, defined as
CW-ratio=magnetic-% Co/wt-% Co

where magnetic-% Co is the weight percentage of magnetic Co and wt-% Co is the weight percentage of Co in the cemented carbide.

The CW-ratio varies between 1 and about 0.75 dependent on the degree of alloying. A lower CW-ratio corresponds to higher W contents and CW-ratio=1 corresponds practically to an absence of W in the binder phase.

It has been found that improved cutting performance is achieved if the cemented carbide has a CW-ratio of from about 0.85 to about 1.00, preferably from about 0.9 to about 0.98, most preferably from about 0.92 to about 0.97.

The coating comprises a homogeneous AlₓTi₁₋ₓN-layer with x=from about 0.6 to about 0.67, preferably x=about 0.62. The thickness of the layer is greater than about 1 μm, preferably greater than about 1.8 μm but less than about 3.8 μm, preferably less than about 3.0 μm. Both the composition and the thickness are measured on the flank face 0.2 mm below the nose radius and in the center of the cutting edge.

The present invention also relates to a method of making the cutting tool insert. The cemented carbide substrate is made using conventional powder metallurgical techniques of milling, pressing and sintering and comprises from about 5 to about 7 wt-% of Co, preferably from about 5.8 to about 6.2 wt-% Co, most preferably about 6.0 wt-% Co, from about 0.15 to about 0.60 wt-% TaC, preferably from about 0.20 to about 0.30 wt-% TaC, from about 0.10 to about 0.50 wt-% NbC, preferably from about 0.10 to about 0.20 wt-% NbC and balance WC. The cemented carbide body may also contain smaller amounts of other elements, but then on a level corresponding to a technical impurity. The coercivity is from about 19.5 to about 24.5 kA/m.

The CW-ratio is from about 0.85 to about 1.00, preferably 0.9 to about 0.98, most preferably from about 0.92 to about 0.97 and is monitored by adding suitable amounts of carbon black or tungsten powder to the powder mixture.

After conventional post sintering treatment, an AlₓTi₁₋ₓN-layer with x=from about 0.6 to about 0.67, preferably x=about 0.62 is deposited using cathodic arc evaporation using a target material consisting of a TiAl-alloy of suitable composition, in an N₂ gas atmosphere. The total thickness of the layer is greater than about 1 μm, preferably greater than about 1.5 μm but less than about 3.8 μm, preferably less than about 3.0 μm.

The present invention also relates to the use of the insert according to above for parting and grooving in heat resistant super alloys and stainless steels such as Inconel 718, Sanmac 304L and austenitic stainless steels at a cutting speed of from about 30 to about 250 m/min and a feed of from about 0.05 to about 0.2 mm/rev.

The invention is additionally illustrated in connection with the following examples, which are to be considered as illustrative of the present invention. It should be understood, however, that the invention is not limited to the specific details of the examples.

### EXAMPLE 1 (INVENTION)

A. A homogeneous (Ti, Al)N-layer was deposited by cathodic arc evaporation on cutting inserts made of cemented carbide with a composition of 6 wt-% Co, 0.16 wt-% NbC, 0.23 wt-% TaC and balance WC and a coercivity of 22.5 kA/m corresponding to an average grain size of about 1.2 μm and a magnetic Co-content of 5.7 wt-% corresponding to a CW-ratio of 0.95. The layer was deposited using a target material consisting of a Ti₃₃Al₆₇ alloy. The arc evaporation was performed in an N₂ gas atmosphere. The thickness of the layer was 2.5 μm as measured on the flank face 0.2 mm below the nose radius and in the center of the cutting edge. The layer consisted of homogeneous Al_{0.62}Ti_{0.38}N as determined by SEM-EDS.

### EXAMPLE 2

B. (commercially available). Cemented carbide grooving inserts in with the same composition and physical properties as in A were coated with a 4.4 μm PVD (Ti, Al)N multilayer consisting of a sequence of homogeneous Ti_{0.5}Al_{0.5}N layers and lamella layers with alternating layers of TiN and Ti_{0.5}Al_{0.5}N. This sequence was repeated twelve times. The thickness of the homogeneous Ti_{0.5}Al_{0.5}N-layers was 0.1-0.2 μm and the thickness of the lamella layers was 0.1-0.2 μm. The thickness of each individual TiN or Ti_{0.5}Al_{0.5}N-layer in the lamella layer was 0.1-20 nm. The average composition of the multilayer was Ti_{0.8}Al_{0.2}N measured with SEM-EDS.

### EXAMPLE 3

Inserts A and B were tested in grooving and profiling of a groove in a cast austenitic stainless steel component. The outer diameter of the groove was 160 mm, the inner diameter 131 mm and the width of the groove 6 mm.

| | |
|---|---|
| Operation: | Grooving and profiling |
| Material: | Cast austenitic stainless steel, CMC 15.21 |
| Insert-style: | N123G2-0300-0003-TF |
| Cutting speed: | 60 m/min |
| Feed: | 0.15 mm/r |
| Time per component: | 3 min |

Results in number of finished components and tool life in minutes:

| | |
|---|---|
| Grade A (invention) | 59 components, 177 min in cut |
| Grade B (prior art) | 15 components, 45 min in cut |

### EXAMPLE 4

Inserts A and B were tested in grooving and turning of a cone in Inconel 718. The outer diameter of the cone was 47 mm and the inner diameter 16 mm.

| Operation: | Turning and grooving | | |
|---|---|---|---|
| Material: | Inconel 718, CMC 20.22 | | |
| Insert-style: | N123H2-0400-0004-TF | | |
| | Grade A (invention) | | Grade B (prior art) |
| Cutting speed: | 50 | m/min | 45 m/min |
| Feed grooving: | 0.08 | mm/r | = |
| Feed turning: | 0.13 | mm/r | = |
| Cutting depth: | 2 | mm | = |

Results: The tool life of Grade A was four components and these were finished in 3 min and 17 s. The tool life of inserts B was two components and these were finished in 3 min and 31 s.

### EXAMPLE 5

Inserts A and B were tested in grooving of Inconel 718. The outer diameter of the groove, D_{O}, was 100 mm, the inner diameter, Dᵢ, 80 mm and the width of the groove 3 mm.

| | |
|---|---|
| Operation: | Grooving |
| Material: | Inconel 718, CMC 20.22 |
| Insert-style: | N123G2-0300-0002-GF |
| Cutting speed: | 45 m/min |
| Feed: | 0.08 mm/r |

Results in Spiral Cutting Length (SCL=((D_{O}(outer diameter in mm)+Dᵢ(inner diameter in mm))/2×π/1000)×depth of groove in mm/feed mm/r×number of grooves) and tool life in minutes at a pre-determined flank wear of 0.2 mm.

| | |
|---|---|
| Grade A (invention): | SCL 200 m = 4.4 min |
| Grade B (prior art): | SCL 140 m = 3.1 min |

### EXAMPLE 6

Inserts A and B were tested in grooving of Inconel 718 with Do 100 mm, Dᵢ 80 mm and width 3 mm.

| | |
|---|---|
| Operation: | Grooving |
| Material: | Inconel 718, CMC 20.22 |
| Insert-style: | N123F2-0300-RO |
| Cutting speed: | 45 m/min |
| Feed: | 0.08 mm/r |

Results in Spiral Cutting Length (SCL) and tool life in minutes at a predetermined flank wear of 0.2 mm:

| | |
|---|---|
| Grade A (invention): | SCL 630 m = 14 min |
| Grade B (prior art): | SCL 370 m = 8.2 min |

### EXAMPLE 7

Inserts A and B were tested in grooving of Stainless Steel Sanmac 304L with Do 20 mm, Dᵢ 6 mm and width 3 mm.

| | |
|---|---|
| Operation: | Grooving |
| Material: | CMC 05.21 Sanmac 304L |
| Insert-style: | N123G2-0300-0002-GF |
| Cutting speed: | 225-85 m/min |
| Feed: | 0.07 mm/r |

Results in number of grooves and tool life in minutes at a predetermined flank wear of 0.15 mm:

| | |
|---|---|
| Grade A (invention): | 2200 grooves = 50.6 min |
| Grade B (prior art): | 850 grooves = 19.6 min |

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. Cutting insert for parting and grooving of heat resistant super alloys and stainless steels comprising a substrate and a coating wherein:
said substrate comprises from about 5 to about 7 wt-% Co and from about 0.15 to about 0.60 wt-% TaC and from about 0.10 to about 0.50 wt-% NbC, balance WC, a coercivity of from about 19.5 to about 24.5 kA/m, a CW-ratio of from about 0.85 to about 1.00, and
said coating comprises a homogeneous AlₓTi₁₋ₓN-layer with x=from about 0.6 to about 0.67 and a thickness of greater than about 1 μm but less than about 3.8 μm.

2. The cutting tool insert of claim 1 wherein said substrate comprises from about 5.8 to about 6.2 wt-% Co, from about 0.20 to about 0.30 wt-% TaC, from about 0.10 to about 0.20 wt-% NbC and has a CW-ratio of from about 0.9 to about 9.8.

3. The cutting tool insert of claim 1 wherein said substrate comprises from about 6.0 wt-% Co and has a CW-ratio of from about 0.92 to about 0.97.

4. The cutting tool insert of claim 1 wherein in said coating x is about 0.62 and said layer has a thickness greater than about 1.8 μm but less than about 3.0 μm.

5. A method of making a coated cutting tool insert for parting and grooving of heat resistant super alloys and stainless steels of a substrate and a coating comprising using conventional powder metallurgical techniques of milling, pressing and sintering, the substrate comprising from about 5 to about 7 wt-% Co and from about 0.15 to about 0.60 wt-% TaC and from about 0.10 to about 0.50 wt-% NbC, balance WC, a coercivity of from about 19.5 to about 24.5 kA/m, a CW-ratio of from about 0.85 to about 1.00, and after conventional post-sintering treatment, depositing a coating comprising a homogeneous AlₓTi₁₋ₓN-layer with x=from about 0.6 to about 0.67 by cathodic arc evaporation using a target material of TiAl-alloy in an N₂ gas atmosphere whereby the total thickness of the coating is greater than about 1 μm but less than about 3.8 μm.

6. The method of claim 5 wherein said substrate comprises from about 5.8 to about 6.2 wt-% Co, from about 0.20 to about 0.30 wt-% TaC, from about 0.10 to about 0.20 wt-% NbC and has a CW-ratio of from about 0.9 to about 9.8.

7. The method of claim 5 wherein said substrate comprises from about 6.0 wt-% Co and has a CW-ratio of from about 0.92 to about 0.97.

8. The method of claim 5 wherein in said coating x is about 0.62 and said layer has a thickness greater than about 1.8 μm but less than about 3.0 μm.

9. Use of an insert of claim 1 for parting, grooving in heat resistant super alloys, stainless steels and austenitic stainless steel at a cutting speed of from about 30 to about 250 m/min and a feed of from about 0.05 to about 0.2 mm/rev.
